(19) United States
(12) Patent Application Publication
(10) Pub. No.: US 2021/0034043 A1
(43) Pub. Date: Feb. 4, 2021

(54) INDUSTRIAL MANUFACTURING PLANT AND METHOD FOR AN AUTOMATED BOOKING OF MANUAL ACTIVITIES

(71) Applicant: TRUMPF Werkzeugmaschinen GmbH + Co. KG, Ditzingen (DE)

(72) Inventors: Klaus Bauer, Ditzingen (DE); Eberhard Wahl, Weilheim (DE); Manuel Kiefer, Sinsheim (DE)

(21) Appl. No.: 17/069,021

(22) Filed: Oct. 13, 2020

Related U.S. Application Data
(63) Continuation of application No. PCT/EP2019/059869, filed on Apr. 17, 2019.

(30) Foreign Application Priority Data
Apr. 26, 2018 (DE) 102018110063.9

(51) Int. Cl. G05B 19/418; G06Q 10/06

(52) U.S. Cl. CPC G05B 19/41865; G05B 2219/32423; G06Q 10/06311

(57) ABSTRACT

A method for the automated booking of manual activities carried out by a worker in an industrial manufacturing plant while processing a workpiece is disclosed. The booking is performed in a digital control system for the creation of a digital process chain of the manufacturing. The digital process chain includes activity profiles, each of which is assigned to a manual activity. The method includes: providing movement data of a manual activity to be booked; providing position data of the manual activity to be booked; evaluating the movement data and the position data, wherein the movement data and the position data are input data of a classification process in which the input data are classified with respect to the activity profiles and a specific activity profile is output for the movement data; and booking the output specific activity profile in the digital process chain of the workpiece.

### CROSS REFERENCE TO RELATED APPLICATIONS

This application is a continuation of and claims priority under 35 U.S.C. § 120 from PCT Application No. PCT/EP2019/059869, filed on Apr. 17, 2019, which claims priority from German Application No. 10 2018 110 063.9, filed on Apr. 26, 2018. The entire contents of each of these priority applications are incorporated herein by reference.

### TECHNICAL FIELD

The present invention relates to a method for booking manual activities in a digital control system of an industrial manufacturing plant, in particular in metal and/or sheet metal processing. Furthermore, the invention relates to an industrial manufacturing plant, in particular in metal and/or sheet metal processing.

### BACKGROUND

As an example of the metal processing industry, in industrial metal and/or sheet metal processing, many parts of different sizes are often fed to different processing steps. For example, workpieces, e.g., laser cut parts produced from a preformed base material or punched sheet metal parts, are manually sorted at a workstation with a machine tool and fed to a subsequent sequence of manual and machine processing steps. Workpieces in industrial metal and/or sheet metal processing are, for example, sheet metal parts and metal parts.

Processing steps of workpieces include automated machine processing steps, such as laser cutting or punching, and manual processing steps. The latter are at least partially based on manual activities. Manual activities include the processing of workpieces by drilling, milling, riveting, sawing, hammering, joining (plugging, screwing, etc.), clamping, and deburring. For example, such a manual activity of a worker when processing a workpiece is part of a manual processing step performed at a manual workstation in the industrial manufacturing plant for metal and/or sheet metal processing. Manual activities also generally include the handling of workpieces such as transporting, sorting, stacking, picking, loading and unloading machines at or between manual and automated workstations, and the commissioning of workpieces.

The concepts disclosed herein refer to a manufacturing process of a workpiece that includes several manual processing steps, wherein the manual processing steps may form a sequence that is interrupted by automated processing steps. This is referred to herein as a processing process chain.

If processing steps are carried out, these are to be booked in a digital control system on the workpiece or the associated processing plan. Such booking processes lead to a digital process chain of the manufacturing process of a workpiece. The process chain digitally reflects the progress of manufacturing and allows it to be compared with the processing plan. An example of a booking process is the booking of a completed processing step (change of the current status) in a production control program of the digital control system (also production control system). The status generally concerns the current position in a processing plan of an order. The processing plan generally includes not only processing steps, but also necessary intermediate results such as a transport from one workstation to the next.

The production control program or the production control system provides access to the digital data of an order, in particular the current digitally stored status of the processing of the workpieces or the processing steps that have already been performed and those that are still pending. The production control program can also output each individual order, the respective status of a processing plan, the location of a workpiece in a manufacturing plant, etc. to a display device such as a screen, tablet, or smartphone. Furthermore, the production control program can be set up to control the sequence of, e.g., automated processing steps, such as controlling machines.

### SUMMARY

An aspect of this disclosure is based on the objective of making manual processing steps in a digital control system accessible as part of a digital process chain of manufacturing and, in particular, to support or carry out the creation of such a digital process chain automatically. In other words, an objective of this disclosure is to image a worker and his manual activities in the form of a digital shadow in the digital control system.

At least one of these objectives is solved by the method and by the industrial manufacturing plant described below.

In an aspect a method for the automated booking of manual activities is disclosed. These manual activities are carried out by a worker in an industrial manufacturing plant when manufacturing a workpiece. Herein, manufacturing includes the processing (e.g., processing steps) and handling (e.g., transport and positioning) of a workpiece. The booking performed in a digital control system for the creation of a digital process chain of manufacturing, wherein the digital process chain includes activity profiles that are each assigned to a manual activity. The method includes the steps: providing movement data of a manual activity to be booked; providing position data of the manual activity to be booked; algorithmically evaluating the movement data and the position data, wherein the movement data and the position data are input data of a classification process in which the input data are classified with respect to the activity profiles and a specific activity profile is output for the movement data; and booking the output specific activity profile in the digital process chain of the workpiece.

In another aspect, an industrial manufacturing plant for a manufacturing of workpieces is disclosed, the manufacturing including manual activities by a worker and optionally automated processing steps on the workpieces. A manufacturing of the workpiece is mapped in a digital process chain. The manufacturing plant includes at least one manual workstation, at which one or more manual activities can be carried out by the worker. Furthermore, the manufacturing plant includes a system for detecting a movement of the worker or an element that is moved by the worker. The movement occurs when a manual activity is carried out. The manufacturing plant also includes a system to detect a position in the industrial manufacturing plant where the detected movement of the worker or moved element takes place. Accordingly, the movement data of the manual activity and position data of the manual activity can be provided to a digital control system of the manufacturing plant. The digital control system is configured to create the digital process chain, which includes several activity profiles, each assigned to a manual activity, and digitally maps the production of the workpiece. For this purpose, the control system includes an algorithmic data evaluation unit which is configured to classify input data, which are formed by the movement data and the position data of the manual activity, with respect to the activity profiles and to output a specific activity profile for a recorded movement of the worker or the moved element. Furthermore, the control system is configured to book the specific activity profiles, which were output, in the digital process chain.

Further embodiments can each optionally include one or more of the following features.

The assignment of a manual activity to a digital activity profile, the associated creation of the digital process chain, and the corresponding bookings of manual activities digitally image manual and machine processing steps.

Activity profiles can be defined by a number of features, especially motion features, as they are individually characteristic for manual activities such as drilling, milling, riveting, sawing, hammering, joining (plugging, screwing, etc.), clamping, deburring, transporting, sorting, stacking, picking, loading and unloading of machines and commissioning of workpieces. Such features include specific movement trajectories of, e.g., a movement of a worker or an element, especially the spatial course of the movement trajectory, spatial characteristics of the movement trajectory, and/or a repetition number of the movement trajectory. Furthermore, the characteristics of an activity profile can include a duration of the movement along the movement trajectory, a start point in time and/or an end point in time of the movement along the movement trajectory, as well as a point in time at which the movement trajectory takes place within a workpiece-specific machining process. Furthermore, an activity profile can be characterized by the specific worker (master craftsman, apprentice, unskilled worker etc.) who performs the movement along the movement trajectory.

In order to be able to provide movement data of a manual activity to be booked for algorithmic evaluation, the method can also include the following steps: detecting a movement of the worker during the manual activity or an element moved by the worker during the manual activity; generating movement data describing the movement of the worker or the moved element; and feeding the movement data as input data to at least one input of the classification process.

The detection of the movement of the worker or the moved element can be done with a sensor system that outputs motion-specific coordinate data sets. The sensor system can have, for example, an acceleration sensor, a position sensor, and/or a barometer sensor. These can be configured as MEMS-based sensors in particular. For detection, a sensor can be worn by the worker on a part of the body, in particular, on an arm as a wristband or glove, on a leg, or on the head. This allows a specific tracking of a movement of the corresponding body part. The sensor system may also include a sensor that detects the movement of the moved element.

In order to be able to provide position data of a manual activity to be booked for the algorithmic evaluation, the method can also include the following steps: determining the position data for the position in the industrial manufacturing plant, where the detected movement of the worker or moved element takes place, and feeding the position data as input data to at least one input of the classification process.

To determine a position in the industrial manufacturing plant, 2D or 3D coordinates can be defined over the area of the manufacturing plant. Furthermore, sensors for specific workstations or storage facilities can be defined in 2D or 3D. The determination of the position data can be done with an indoor location system, which is configured to determine the position of the worker, the moved element, or the workpiece in the manufacturing plant. For example, the indoor location system can be based on several transceiver units and at least one mobile unit on the worker, moved element, or workpiece.

In some embodiments, e.g., especially when movements of the moved element are detected, the associated position data may already be given by the workstation in the industrial manufacturing plant, where the moved element is installed as part of the workstation.

In further embodiments, the detecting of the movement of the worker or the moved element and/or the determining of the position data can be done with a camera system and image recognition.

A data evaluation based on a classification algorithm, in particular a self-improving algorithm, can have one or more of the following evaluation steps: data processing of the input data with a first processing data set and a first processing algorithm to generate intermediate data; in particular, a data processing of such intermediate data and subsequently similarly obtained further intermediate data with further processing data sets and further processing algorithms to form further intermediate data; repeating the data processing according to a given repeat instruction; determining of processing data sets and processing algorithms using test data sets. Test data sets can include input data and associated activity profiles.

In particular, determining of the processing data sets and processing algorithms can be based on the following steps: reading input data of the test data sets; determining activity profiles with predefined processing data sets and/or processing algorithms; comparing determined activity profiles with activity profiles, which are assigned to the read input data; modifying the processing data sets and/or processing algorithms based on the results of the comparing and according to a predetermined improvement algorithm; and repeating the above steps until the activity profiles determined from the input data of the test data sets match the intermediate data from the test data sets at a predetermined minimum match rate.

Processing data sets can include data sets with assigned factors (weights), wherein the factors individually weight the data to be processed. Processing algorithms can be arithmetic, combinatorial, and/or logical processing algorithms, which further process the data to be processed according to the specified combinatorics, arithmetic, and/or logic.

The data evaluation can also be configured to use multiple improvement algorithms, and to use preferably improvement algorithms that reach a given matching goal faster or more reliably with given scales. The data analysis can further be configured to use several repetition algorithms and to use preferably repetition algorithms that reach a given matching goal faster or more reliably with given scales.

In some embodiments, the algorithmic evaluation of the movement data can be performed with at least one neural network. Thereby, the neural network is configured for specific manual activities in the industrial manufacturing plant. Alternatively or additionally, it can further improve itself continuously. The movement data and the position data are digital input values of the neural network and the activity profiles are represented as digital output classes in the neural network.

In general, a neural network can be a convolutional neural network. In particular, convolutional layers can be specifically adapted to the detected movement of the worker or to the detected movement of the moved element. In some embodiments, a first neural network can be provided for detected movements of the worker during manual work and a second neural network for detected movements of an element moved by the worker.

The concepts disclosed herein make it possible that manual activities can be safely booked without additional effort. The concepts are particularly adaptable with the employment of self-learning and/or self-improving algorithms to individual processing methods of the executing person. Together with an automated user legitimation of a worker, the booking can also replace a handwritten signature or the classic user login for verification.

### DESCRIPTION OF DRAWINGS

Herein, concepts are disclosed that allow at least partly to improve aspects of the prior art. In particular additional features and their usefulness result from the following description of embodiments on the basis of the drawings.

FIG. 1 is a schematic overview of an industrial manufacturing plant.

FIG. 2 is a perspective view of an industrial manufacturing plant with manual and automated workstations.

FIG. 3 is a sketch to illustrate the classification process.

FIG. 4 is a flowchart to illustrate the method for automated booking of a manual activity.

### DETAILED DESCRIPTION

In general, it is suggested herein to image a worker and his activities in the form of a digital shadow in digital production control. In particular, the inventors aim to store as many, preferably all, steps of the manufacturing process for an order and its associated processing plan in a digital process chain. In addition to automated processing steps, it is therefore one of the inventors' aim to book as many manufacturing steps as possible from the manual area, such as manual processing steps and transport and positioning steps carried out by the worker, into the digital process chain. For this purpose, it is proposed to generate the data necessary for booking a manual activity generically from a pattern recognition and under consideration of further conditions of the surrounding. An image of the digital shadow of the worker is created, e.g., by means of worn sensor technology (e.g., an acceleration sensor on the hand) and/or external sensor technology (e.g., an image processing) within the framework of the concepts disclosed herein.

In particular, the image is done using pattern recognition of movements of manual activities recorded with sensors, for example, in comparison with activity profiles. For example, raw data of the movement are examined for typical movement patterns during drilling, milling, etc.

The knowledge of the manufacturing plant represents an essential basis for the allocation and is available as a digital shadow of the manufacturing plant, either completely or partially digital. Thus, the additional knowledge of the surrounding that is available at the time and place of manual activity can be included in the evaluation. At which manual workstation a manual activity to be recorded was carried out can be identified, for example, using the location information of the worker.

The procedure proposed herein may provide the correct knowledge of the performed manual activity with an increased accuracy and to book it in the production control, in the production control program, or in the production control system.

The production control system may include an MES (Manufacturing Execution System) and an indoor location system (hereinafter referred to as location system). The MES can be configured to be connected to one or more manual workstations or automated workstations located in a production hall, e.g., machine tools, via wireless or wired communication links. In general, the MES can be used to control process workflow/production steps in the industrial production of workpieces with the workstations. For this purpose, the MES can receive information about the process workflow/manufacturing steps as well as status information of the workstations. The MES can be implemented in a data processing device. This can be a single electronic data processing device (server) or a group of several data processing devices (server group/cloud). The data processing device or group can be located locally in the manufacturing plant or can be set up externally in a decentralized manner.

One or more processing steps can be specified for each workpiece to be produced and each workpiece group. Processing steps in metal and/or sheet metal processing include, for example, separating, cutting, punching, forming, bending, joining, surface treatment, etc. of the workpieces. Such processing steps can be stored together in a processing plan. A processing plan can be intended for several workpieces in a workpiece group.

The MES can be setup such that the processing plans of the workpieces to be produced can be created and processed in it. Thereby, the MES can also display the status of the workpieces. This means that the MES can output both the sequence of the processing steps and the processing steps already performed. Advantageously, the MES can also be set up to assign individual processing plans to the workstations. The MES can also be designed to allow manual or automated intervention in the processing steps of a processing plan at any time. This has the advantage that during the production process several different processing plans can react very flexibly to different, especially unexpectedly occurring events. These events can be, for example: a change in the priority of processing plans or production orders, a new high-priority production order, cancellation of a production order, missing material, e.g., in the case of incorrect delivery, machine failure, lack of qualified personnel, accidents, detection of faulty quality in a production step, etc.

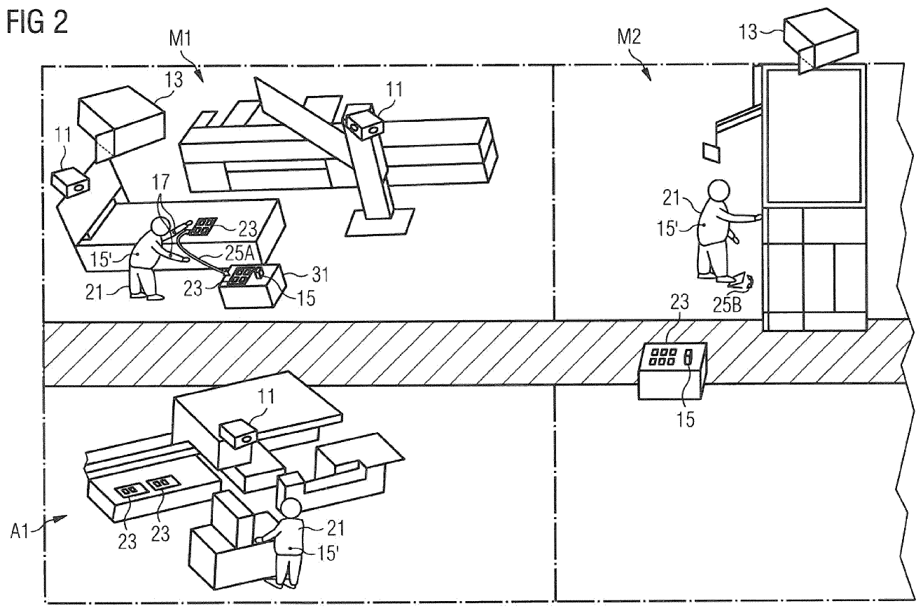

The locating system is designed for indoor positioning of mobile locating units (see FIG. 2). It can have several stationary and/or mobile transceiver units and can cooperate with the MES for digital assignment. The mobile locating units can be located via the transceiver units by means of runtime analysis. The transceiver units can be installed on the hall ceiling, hall walls, machine tools, storage structures, etc. at fixed positions. The positions of the transceiver units are stored, for example, in a digital site plan of the production hall. A mobile locating unit can also be operated as a mobile transceiver unit.

In order to classify the manual activity to be booked, raw data of the movement can be analyzed with a data evaluation (e.g., based on a neural network) to determine the activity profiles.

If absolute coordinates of a movement trajectory of the worker in the manufacturing plant are available, they can be clearly assigned in space and time with their characteristics to a known activity profile. The recording of the movement can be done in one or more of the following ways:
optical motion detection: One or more cameras are used to detect spatially resolved movements.
localizing-based motion detection: Movements are detected by means of indoor detection such as the “Ultra Wide Band (UWB)” technology for indoor detection.
sensor-based motion detection: Information about the movement taking place is obtained with sensors such as acceleration sensors and gyro sensors. Sensors can be provided on the worker (e.g., on the worker's hand rest) or on an element moved by the worker (e.g., a foot switch).

The approaches of motion capture can complement each other for a higher plausibility and/or robustness of the booking. Although sensors and indoor localization can be at least partially replaced by the use of surveillance cameras and image processing, stationary cameras installed at the location of the manual activity to be booked often come up against acceptance limits and data protection considerations.

Thus, it is herein proposed as a preferred solution to perform the motion detection of manual activity with an indoor location such as UWB technology and motion sensor technology. This leads to a high flexibility in the implementation with a corresponding economic efficiency, because especially the indoor location can also be used to obtain the position data of the manual activity.

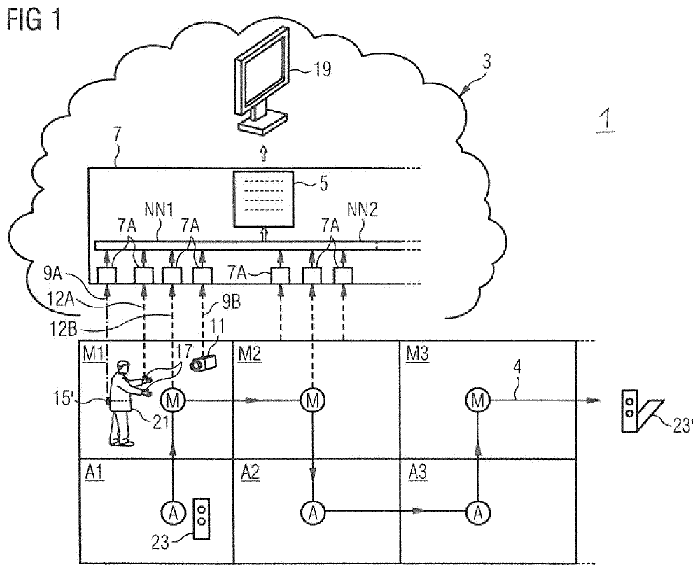

FIG. 1 illustrates the method for the automated booking of a manual activity by means of a schematic overview of an industrial manufacturing plant 1, which is connected to a digital control system 3 via data links.

In the industrial manufacturing plant 1, three manual workstations M1, M2, M3 and three automated workstations A1, A2, A3 are shown schematically as examples. From a workpiece 23, which, for example, was produced from a flat material using a laser cutting machine at the automated workstation A1, a final product 23′ is produced at the manual and automated workstations. This means that manual activities M are performed by a worker 21 and automated processing steps A by machines on workpiece 23 according to a processing plan. The manual activities M include, for example, manual processing such as drilling, milling, or bending of workpiece 23, as well as manual handling such as sorting, transporting, or loading machines. The manufacturing process in manufacturing plant 1 is illustrated in FIG. 1 with an arrow 4, which runs through the various processing steps.

The production process is controlled and monitored by the digital control system 3. The digital control system 3 includes an algorithmic data evaluation unit 7 for this purpose.

The data evaluation unit 7 is set up to map the production process in a digital process chain 5, in which the manual and machine processes performed on the workpiece are stored. Information on the automated processing steps A is digitally available to the machines at workstations A1, A2, A3 and can be easily incorporated into the digital process chain. This is not the case for manual processing. In order to be able to map manual processes in the digital process chain 5 nevertheless, the data evaluation unit 7 is also set up to execute a method for the automated booking of manual activities M that are carried out by worker 21 in an industrial manufacturing plant 1 when manufacturing the end product 23′.

In the data evaluation unit 7, an algorithm-based data evaluation is performed. In FIG. 1, separate algorithms NN1, NN2 are shown as examples for the manual workstations M1 and M2.

The data evaluation unit 7 receives data via data inputs 7A, which are evaluated with the algorithms NN1, NN2. The data belong to manual activities to be booked at the manual workstations M1, M2, M3. Various data are provided.

On the one hand, the data to be evaluated includes position data 9A, e.g., of a mobile unit 15′ of an indoor location system, which is used to record a position of the worker 21, where he performs the manual activity M of the workstation M1 in the manufacturing plant 1. Alternatively or additionally, position data 9B of the position of the manual activity in manufacturing plant 1 can be provided, for example, by means of image analysis from image data of a camera 11.

On the other hand, the data to be evaluated includes movement data 12A from motion sensors 17, which are provided on the hands of the worker 21, for example, and thus capture movement trajectories as an example of movement data that characterize, for example, picking up, lifting and placing the workpiece 23. The movement data 12A belong to a movement of the worker 21 during the manual activity M. They are recorded by the movement sensor 17 within the scope of the manual activity to be booked and include, in addition to the movement trajectory, e.g., spatial characteristics (direction of movement, speed of movement), a repetition number of identical movement trajectories, a duration of the movement along the movement trajectory, a start point in time and/or an end point in time of the movement, as well as a point in time at which the movement trajectory takes place in a workpiece-specific machining process.

Alternatively or additionally, movement data of a movement of an element moved by worker 21 during manual activity M can be recorded. This can be done, for example, with a motion sensor on the moved element (primary/direct motion information). An example of this is the movement of a foot switch at a manual workstation, as shown schematically in FIG. 2. Other motion sensors can be based on secondary information of the movement, for example, the power consumption of a hand tool. Corresponding movement data 12B of the moved element is transferred to data inputs 7A.

The movement data 12A, 12B and the position data 9A, 9B are input data regarding movement and location of manual activity for the algorithmic data evaluation unit 7.

The data evaluation with the algorithms NN1, NN2 includes a classification process, which performs a classification of the input data regarding possible activity profiles. As a result, the classification process, or the underlying algorithmic evaluation, outputs a specific activity profile for the detected movement of the worker 21 or the element moved by the worker 21. The output specific activity profile is booked in the digital process chain 5 of the workpiece 23 with regard to the corresponding manual workstation M1, M2, M3.

The digital control system 3 can output the digital process chain for a controller of the manufacturing plant on a display 19, e.g., a monitor, so that the controller can track and monitor the status of the manufacturing process of the workpiece 23.

FIG. 2 shows a schematic partial view of the industrial manufacturing plant 1. The fully automated workstation A1 of manufacturing plant 1 is, for example, a flatbed machine tool that allows automated processing steps to be stored digitally in the digital process chain 5. Correspondingly cut workpieces can be directly assigned to processing plans.

Manufacturing plant 1 also has the manual workstation M1 and a partially automated workstation M2. Furthermore, one can see transport trolley 31, which is used to transport workpieces 23 from one workstation to the next. Cameras 11 and an indoor location system is also installed in the manufacturing plant 1 to detect a movement of worker 21 during manual operation, movement of an element moved by worker 21 during manual operation, or a transport trolley 31. The cameras 11 supply image data to an image recognition system to derive movements in acquired images. The indoor location system uses stationary transceiver units 13 and/or mobile transceiver units 15 (also called mobile units) to determine, for example, mobile units 15′ carried, e.g., by workers 21, and thus the positions of workers 21, in the manufacturing plant 1. With the appropriate resolution, movements of workers 21 can also be determined.

At the manual workstation M1, a sorting process is illustrated in which the worker 21 places workpieces 23 from a sorting table on the transport trolley 31. The depositing process takes place along a movement trajectory 25A. This is recorded by motion sensors on the hands of the worker 21 and the corresponding movement data of this manual activity is transferred to the digital control system, in particular, to the data inputs 7A of the data evaluation unit 7.

The manual workstation is additionally equipped with cameras 11 for image acquisition, which can be used independently or in addition to determine the movement trajectories 25A.

At the manual workstation M2, a manual processing step of drilling is indicated by a foot switch 33. Each time the worker 21 presses the footswitch to drill, a corresponding signal is output. This signal corresponds to a movement trajectory 25B of the foot plate of the foot switch 33 and is also transmitted to the digital control system, in particular, to the data inputs 7B of the data evaluation unit 7.

The indoor location system of the manufacturing plant enables the generation of position data of the mobile units 15′, which are carried by the workers 21, for example, while they perform manual activities at the manual workstations in the manufacturing plant 1. These position data are transferred to the data inputs 7A of the data evaluation unit 7.

In summary, FIGS. 1 and 2 show an industrial manufacturing plant 1 for the production of workpieces 23. The production includes manual activities of the workers 21 and automated production steps on the workpieces 23. The manufacturing plant 1 also includes systems for detecting a movement of a worker 21 (e.g., the indoor location system, the camera image-based motion analysis system, motion sensors). Alternatively or in addition, the manufacturing plant 1 includes a system to detect an element moved by the worker 21 (the foot switch 33). These systems allow to know or at least to determine a location in the industrial manufacturing plant, where the detected movement of the worker 21 or the element moved by the worker 21 takes place. The systems can thus provide movement data of the manual activity and position data of the manual activity for further evaluation.

For the further evaluation and booking of manual processing steps, industrial manufacturing plant 1 includes a digital production control system that is designed to create the digital process chain. The process chain includes several activity profiles, each assigned to a manual activity, and reflects the production process of the workpiece 23.

The production control system includes an algorithmic, especially self-improving data evaluation, which is designed to classify input data, here the movement data of the manual activity together with the position data of the manual activity, with respect to the activity profiles and to output a specific activity profile for a detected movement of the worker 21 or the moved element 33.

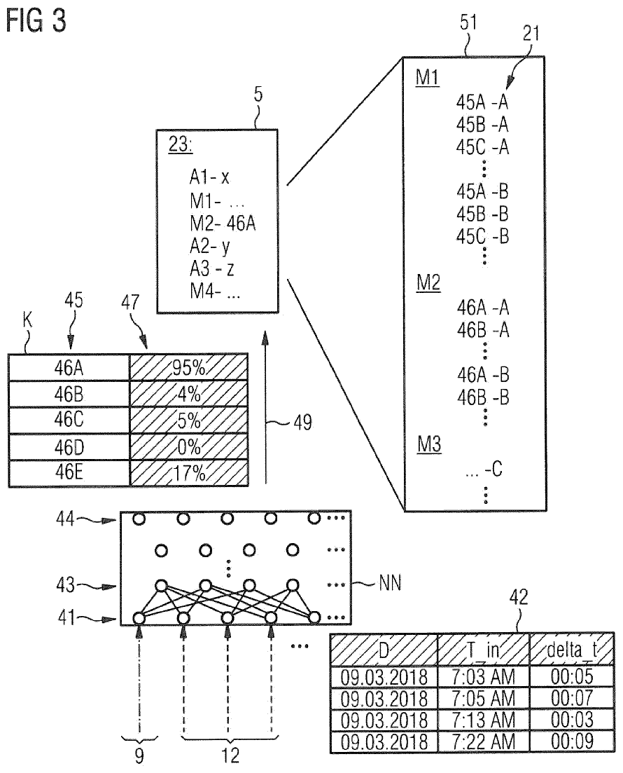

FIG. 3 shows schematically aspects of an exemplary classification process, which is schematically indicated as neural network NN. Position data 9 and movement data 12 are fed as input values to input node 41 of the network NN. On the one hand, direct data on the movement of the worker 21 (arm up/down) or the foot switch 33 (pressed, released) can be transferred to the network NN. Such data essentially determine the movement trajectory. Further movement data include a day D, a start point in time T_in a manual activity and a duration delta_t of a manual activity. Table 42 shows data for four drillings indicated, which were performed on the same day in the morning one after the other. Such data may also be associated with input node 41 of the network NN.

In several layers 43 of the network NN, the values are calculated in a weighted manner with each other. The calculation is performed with the help of algorithms that have been trained for a corresponding classification and, for example, have been trained in the context of “intelligent” algorithms. The weights are determined with test activities, for example. Within the framework of, e.g., self-learning algorithms, the data evaluation classifies different processing procedures and can, for example, recognize the workers carrying out the procedures after they have been carried out several times.

The output nodes 44 of the network NN are assigned with output values 47, which were determined for the possible activity profiles as a result of the classification. They represent a prediction of probability for the activity profile to be booked.

In FIG. 3, a table K shows exemplary initial values 47 for activity profiles “Drilling” 46A, “Transport along known movement trajectory 25A” 46B, “Bending” 46C, “Grinding” 46D and “Deburring” 46E at manual workstation M2. In the example, the position data and movement data of the manual activity at manual workstation M2 are classified with 95% as “Drilling”. Accordingly, a booking 49 of the manual activity in the digital process chain 5 is initiated.

Processing steps A1-X, A1-Y, and A1-Z of the automated workstations A1, A2, and A3 are also stored in the digital process chain 5.

FIG. 3 also schematically shows a database 51 of possible activity profiles assigned to the different manual workstations M1, M2, M3. The activity profiles can be specific for workers A, B, C. For example, workstation M1 includes the activity profiles 45A-A, 45B-A, 45C-A . . . for worker A, the activity profiles 45A-B, 45B-B, 45C-B . . . for worker B etc., and workstation M2 includes the activity profiles 46A-A, 46B-A for worker A, and the activity profiles 46A-B, 46B-B . . . for worker B.

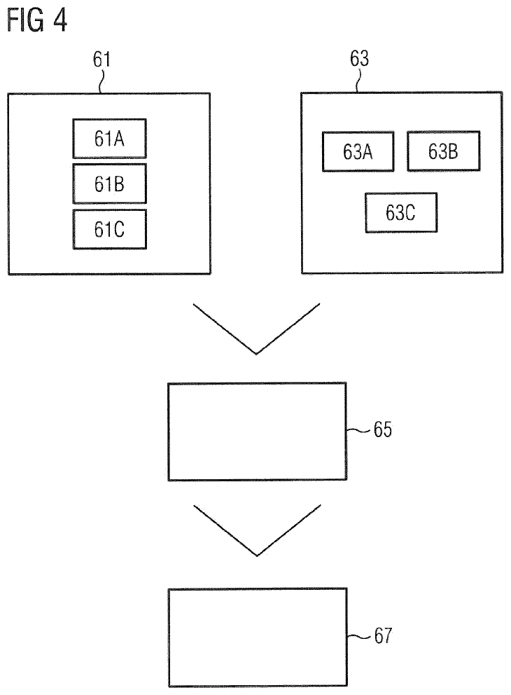

FIG. 4 shows a flowchart to illustrate the method for automated booking of manual activities.

Starting point of the procedure are steps 61 and 63 of providing movement data of a manual activity to be booked and providing position data of the manual activity to be booked. For example, step 61 of providing movement data may include step 61A, where a movement of a worker in the manual activity or an item moved by the worker in the manual activity is recorded. In addition, the step 61 of providing movement data may include the step 61B, where movement data describing the movement of the worker or moved element is generated for the detected motion. The step 63 of providing position data of the manual activity to be booked may include, for example, determining (step 63A) the position data for the position in the industrial manufacturing plant, where the detected movement of the worker or the moved element takes place, in particular camera-assisted or using indoor location. Furthermore, the position data can be specified by the workstation in the industrial manufacturing plant (step 63B). In steps 61C and 63C, the movement data and the position data are fed as input data to at least one input of the classification process.

In step 65, an algorithmic evaluation of the movement data and the position data is performed and a specific activity profile for the movement data is output. Based on this, the output specific activity profile is booked in the digital process chain of the workpiece in step 67.

In a further example of an implementation for explaining the evaluation, reference is again made to the sorting process at the manual workstation M1, where a large number of workpieces with different shapes and different weights are sorted. The worker has an acceleration sensor on each hand to detect movement. In a training phase, the algorithmic data evaluation has been taught with the movement trajectories of the hand during the sorting process in empty state (without workpiece). In addition, the data evaluation learned to recognize load-dependent movement patterns of the worker's hand a further teach-in process with defined masses.

During sorting, the control system can detect by pattern analysis that the worker has grasped a workpiece and is putting it down. This can be detected in parallel with cameras, for example, to additionally recognize where a workpiece was gripped and where the hand was when it was put down. Furthermore, sensors can be used to detect the mass of the deposited parts during sorting, for example. As source, target, and roughly the mass are known, the pattern analysis can be used to derive the material movement during sorting. A corresponding booking of the sorting process can follow automatically.

In addition to booking the processing operation by pattern recognition, the start of the processing, the duration of the procedure, and the end of the processing can be recorded. A measurement of the start status and the final status can be recorded by further sensor technology. These parameters can also be included in the pattern recognition.

For a direct detection of a movement of the worker, the following sensors can be provided on the worker, for example: Acceleration sensor, magnetic field sensor, rotation rate sensor, or active RFID for spatial resolution. Movement patterns by hand, foot, or arm can thus relate to spatial trajectories, position vectors, and time windows. Cameras for image processing can be installed as sensors in the surrounding, especially IR cameras/thermal imaging cameras. Furthermore, a recognition via ultrasound can be done.

Furthermore, machine data such as power consumption can be indirectly linked to an activity profile. This applies in particular to the recording of moved elements by manual manipulation by the worker. Accordingly, movement patterns for a press beam, a toggle lever, a foot switch can be added, again together with position data and time information.

In some exemplary embodiments, sensors are, for example, integrated in a glove worn by the worker or external sensors are attached directly to the machine.

The classification is based, among other things, on the fact that binary states are present during production, because a worker can only perform one manual activity at a time. The probability to be determined for this manual activity is maximum, whereas the probabilities for the remaining manual activities are low. Such classification tasks can be processed with “deep learning” strategies, for example, with neural networks and especially with folding neural networks (“convolutional neural networks”). In a test phase of the classification, a probability matrix of the existing activity profiles has to be created and verified. Herein, a neural network is understood as a system of interconnected data points, whose values are calculated with each other. The connections of the data points have a numerical weighting, which is adjusted during a training process, so that a correctly trained network reacts correctly to a recognizable movement pattern. The network usually includes of several layers of data points. Each layer has many data points, which lead to a probability evaluation at output data points based on the specific weights on different combinations of input values entered at input data points. Folding neural networks with special folding layers and weights in this layer are used especially in pattern recognition.

Classification processes can be specifically designed for a manual workplace. In some cases, it is possible to use a classification process for several workstations, as long as the same boundary conditions apply, especially for the corresponding activity profiles, for example, the use of the same detecting system for the worker's behavior and the same/similar activity profiles that can be described with the same semantics.

For the algorithmic evaluation, trained nets (fully trained systems) can be used. The algorithmic evaluation can be exposed to a constant adaptation of the underlying network (trainable system, which is continuously trained further on). The latter allows an adaptation to changing conditions and is especially advantageous if activity profiles of a workplace are not permanently constant.

Common methods for algorithmic evaluation can use platforms like “Tensorflow” (“An open source machine learning framework for everyone”) or the convolutional neural network “Alex-Net”, which can be used for many tasks and classification approaches.

As explained above, position data can be provided with an indoor location system. Exemplary disclosure for this can be taken from the following disclosures. For example, methods to support the sorting process of workpieces produced with a flatbed machine tool, in general methods to support the machining of workpieces, are known from the (still unpublished) German patent applications DE 10 2016 120 132.4 (“Werkstücksammelstelleneinheit und Verfahren zur Unterstützung der Bearbeitung von Werkstücken”) and DE 10 2016 120 131.6 (“AbsortierunterstUtzungsverfahren und Flachbettwerkzeugmaschine”) with filing date Oct. 21, 2016. Furthermore, a supporting method for the sorting of, e.g., cut material of a flatbed machine tool is known from the German patent application DE 10 2017 107 357.4 (“Absortierunterstutzungsverfahren und Flachbettwerkzeugmaschine”) with filing date Apr. 5, 2017. From the German patent application DE 10 2017 120 381.8 (“Assistiertes Zuordnen eines Werkstücks zu einer Mobileinheit eines Innenraum-Ortungssystems”) with filing date Sep. 5, 2017, a digital and physical assignment of mobile units, orders, and workpieces is also known. The mentioned German patent applications are incorporated herein by reference in their entirety.

Such an indoor location system has several mobile and/or permanently installed transmitter-receiver units and an analysis unit to detect the position of a mobile locating unit. The transceiver units and the mobile locating unit are configured to generate, transmit, receive, and process electromagnetic signals. The analysis unit is configured to determine the run times of the electromagnetic signals between the transceiver units and the mobile locating unit and to determine the position of the mobile locating unit in the production hall from the run times of the electromagnetic signals. In general, the indoor location system is configured to provide data on the position of the mobile locating unit to the control unit.

In particular, the analysis unit mentioned herein may be an electronic circuit that processes signals, either individually, in combination, or both. In particular, the analysis unit may perform analyses according to predetermined or adjustable analog or digital thresholds. In particular, the analysis unit may include a memory, an arithmetic-logic calculation device, and input and output connections and/or devices.

Generating electromagnetic signals means herein the conversion of electrical power, e.g., from a DC power supply, especially a battery or accumulator, into electromagnetic signals in the radio frequency range or higher frequencies, which are suitable for transmission to further mobile transceiver units (generally for communication).

Processing of electromagnetic signals means herein the analog and/or digital conversion of electromagnetic signals into information, which can be stored and/or further processed and can lead to further actions of the mobile transceiver units.

The mobile transceiver units and the stationary transceiver units therefore have electronic circuits and an electrical power supply and can be configured to process data transmitted with the electromagnetic signals.

The production control and the algorithmic data evaluation unit disclosed herein can be configured for the metal processing industry. In the metal processing industry, machine tools, especially flatbed machine tools, can be configured to create workpieces as output elements for subsequent machining procedures (hereafter also called machining or processing steps). The workpieces may, for example, be produced by a punching or laser cutting machine according to a processing plan in various shapes and quantities from a flat material, in particular, in a sheet form, e.g., a sheet metal or a metal object, e.g., a pipe, sheet metal, or steel plate. The processing plan can be stored in a production control system that monitors and controls the processing processes or in a production control system of a manufacturing plant, especially digitally, and be compared with digital process chains. In the case of a punching or laser cutting machine, for example, the processing plan can contain instructions for controlling where, e.g., with a punching tool or laser cutting beam, the material is to be cut. Information on this can be stored in the digital process chain after execution. The processing plan can include, for example, in the case of a punching or laser cutting machine, instructions for the control where, e.g., with a punching tool or laser cutting beam, the material is to be cut. Information on this can be stored in the digital process chain after execution. The processing plan can also include further information for manual processing steps, such as forming, joining, welding, surface treatment, etc. For this manual processing of the workpieces, the concepts disclosed herein can automate the booking of manual activities, which is based on a classification of the activities into activity profiles. In a digital processing plan, the corresponding information can be stored according to the order information for the industrial processing of workpiece composites, which should finally correspond to the processing steps stored in the digital process chain. The end products mentioned herein have passed through all processing steps according to the assigned processing plan.

In summary, it was explained herein how to digitize manual activities into manual activity profiles by evaluating various parameters such as movement characteristics, frequency, time, duration and other characteristics of the movement execution, such as the location of the manual activity in a manufacturing plant and who performed the manual activity, in order to automate booking processes of manual activities.

It is explicitly stated that all features disclosed in the description and/or the claims are intended to be disclosed separately and independently from each other for the purpose of original disclosure as well as for the purpose of restricting the claimed invention independent of the composition of the features in the embodiments and/or the claims. It is explicitly stated that all value ranges or indications of groups of entities disclose every possible intermediate value or intermediate entity for the purpose of original disclosure as well as for the purpose of restricting the claimed invention, in particular as limits of value ranges.

What is claimed is:

1. A method of automated booking of manual activities to be carried out by a worker in an industrial manufacturing plant during processing and/or handling of a workpiece, the automated booking being performed in a digital control system for creating a digital process chain of the manufacturing, and the digital process chain includes activity profiles, each of which is assigned to a manual activity, the method comprising:
providing movement data of a manual activity to be booked;
providing position data of the manual activity to be booked;
algorithmically evaluating the movement data and the position data, wherein the movement data and the position data are input data of a classification process in which the input data are classified with respect to the activity profiles and a specific activity profile is output for the movement data; and
booking the specific activity profile in the digital process chain of the workpiece.

2. The method of claim 1, further comprising
detecting a movement of the worker during the manual activity or an element moved by the worker during the manual activity;
generating movement data describing the movement of the worker or the moved element; and
feeding the movement data as input data to at least one input of the classification process.

3. The method of claim 2,
wherein the detecting of the movement of the worker or of the moved element is performed with a sensor system that outputs movement-specific coordinate data sets,
wherein the sensor system includes one or more of: an acceleration sensor, a position sensor, or a barometer sensor.

4. The method of claim 3,
wherein the sensor system includes at least one sensor that is worn by the worker on a body part for tracking a movement of the corresponding body part.

5. The method of claim 4,
wherein the at least one sensor is configured to be worn on an arm, a hand, a leg, or a head.

6. The method of claim 3,
wherein the sensor system includes at least one sensor that detects the movement of the moved element.

7. The method of claim 2, further comprising:
determining the position data for the position in the industrial manufacturing plant where the detected movement of the worker or the moved element takes place; and
feeding the position data as input data to at least one input of the classification process.

8. The method of claim 7,
wherein the determination of the position data is carried out with an indoor location system that is designed to determine the position of the worker, the moved element, or the workpiece in the manufacturing plant; and/or
wherein the position data are specified by a workstation in the industrial manufacturing plant at which the moved element is installed as part of the workstation.

9. The method of claim 8,
wherein the indoor location system is based on several transceiver units and at least one mobile unit provided on the worker, on the moved element, or on the workpiece.

10. The method of claim 7,
wherein the detecting of the movement of the worker or the moved element is performed with a camera system and the determination of the position data is performed with an image recognition algorithm.

11. The method of claim 1,
wherein a manual activity of the worker is part of a manual processing step that is carried out at a manual workstation in the industrial manufacturing plant of a metal and/or sheet metal processing plant.

12. The method of claim 1,
wherein the algorithmically evaluating of the movement data is performed with at least one neural network configured and/or continuously improved for specific manual activities in the industrial manufacturing plant, and wherein the movement data and the position data are digital input values of the neural network and the activity profiles are mapped as digital output classes in the neural network.

13. The method of claim 12,
wherein a first neural network is provided for detected movements of the worker during the manual activity and a second neural network is provided for detected movements of an element moved by the worker.

14. The method of claim 1,
wherein each of the activity profiles is determined by one or more of the following features specific to a manual activity: a movement trajectory of a detected movement of the worker or the element; a duration of the movement along the movement trajectory; a start point in time; an end point in time of the movement along the movement trajectory; a point in time at which the movement trajectory takes place in a workpiece-specific machining process; or information about a worker who carried out a movement along a movement trajectory.

15. The method of claim 14, wherein the movement trajectory of the detected movement of the worker or the element includes one or more of a spatial course of the movement trajectory, spatial characteristics of the movement trajectory, or a repetition number of the movement trajectory.

16. An industrial manufacturing plant for manufacturing workpieces, the manufacturing including manual activities by a worker on the workpieces, wherein a manufacturing of a workpiece is mapped in a digital process chain, the industrial manufacturing plant comprising:
at least one manual workstation, at which one or more manual activities can be carried out by the worker;
a system for detecting a movement of the worker or an element moved by the worker in carrying out a manual operation and a position in the industrial manufacturing plant, where the detected movement of the worker or the element takes place, the system providing movement data of the manual operation and position data of the manual operation; and
a digital control system that is configured to create the digital process chain, which includes a plurality of activity profiles, each assigned to a manual activity, and which digitally maps production of the workpiece,
wherein the control system includes an algorithmic data evaluation unit configured to classify input data formed by the movement data and the position data of the manual activity with respect to the activity profiles, and to output a specific activity profile for a detected movement of the worker or the moved element, and
wherein the control system is further configured to book specific activity profiles output in the digital process chain.

17. The industrial manufacturing plant of claim 16,
wherein the data evaluation unit includes a neural network.

18. The industrial manufacturing plant of claim 16,
wherein the system for detecting a movement of the worker or of the moved element comprises a sensor system for detecting the movement of the worker or of the element, which outputs movement-specific coordinate data sets.

19. The industrial manufacturing plant of claim 16,
wherein the system for detecting a movement of the worker or the moved element includes an indoor location system for determining a position in the industrial manufacturing plant, the indoor location system including a plurality of transceiver units provided in the manufacturing plant and at least one mobile unit provided on the worker or the moved element.

20. The industrial manufacturing plant of claim 16,
wherein the system for detecting a movement of the worker or the moved element includes a camera system having at least one camera and an image recognition system.
